(19) United States
(12) Patent Application Publication
(10) Pub. No.: US 2012/0084868 A1
(43) Pub. Date: Apr. 5, 2012

(54) LOCATING DOCUMENTS FOR PROVIDING DATA LEAKAGE PREVENTION WITHIN AN INFORMATION SECURITY MANAGEMENT SYSTEM

(75) Inventor: Klaus Julisch, Rueschlikon (CH)

(73) Assignee: INTERNATIONAL BUSINESS MACHINES CORPORATION, Armonk, NY (US)

(21) Appl. No.: 13/234,703

(22) Filed: Sep. 16, 2011

(30) Foreign Application Priority Data
Sep. 30, 2010 (EP) 10184350.6

(51) Int. Cl. G06F 21/00

(52) U.S. Cl. 726/26

(57) ABSTRACT

A method for locating documents has a step of, on each entity of the plurality of document-storing entities, calculating a respective fingerprint for each document of the documents stored on the entity, a step of transferring the calculated fingerprints by the entities to a data localization server having a fingerprint database for storing the transferred fingerprints, and a step of, at the data localization server, locating copies of a specimen document by calculating a fingerprint of the specimen document and comparing the calculated fingerprint of the specimen document with the fingerprints stored in the fingerprint database.

### PRIORITY

This application claims priority to European Patent Application No. 10184350.6, filed 30 Sep. 2010, and all the benefits accruing therefrom under 35 U.S.C. §119, the contents of which in its entirety are herein incorporated by reference.

The invention relates to a method and to a system for locating documents for providing Data Leakage Prevention (DLP) within an Information Security Management System (ISMS).

### BACKGROUND

An example for illustrating data proliferation in a system 100 is depicted in FIG. 1. In the system 100, the original document 101 is owned by an executive. But, in the system 100, there are further copies of the original document 101 proliferated in the system 100. For example, there are earlier drafts 102 from the executive's subordinates. Further, there may be backup and temporary copies 103 of the earlier drafts 102.

Moreover, there may be a copy 104 on the executive's memory stick. Moreover, there may be temporary copies 105 on the executive's hard drive.

Also, copies 106 may be sent out by the executive. Further, there may be backup copies 107 of said sent-out copies 106. In sum, FIG. 1 shows an example of data leakage.

Conceptionally, DLP prevents documents, in particular sensitive documents, from leaking into unauthorized hands. In practice, the term DLP is used synonymously with concrete implementations. At least three implementations are known that have been equated with a DLP: Host-based DLP, server-based DLP and network-based DLP.

In host-based DLP, a DLP agent is installed on each end user computer of an enterprise's system. The DLP agent may prevent sensitive documents from leaking into unauthorized destinations within or outside the enterprise's system. In many ways, the host-based DLP may be compared to a virus scanner as it also runs on end user computers to protect them from threats.

In server-based DLP, a DLP agent is installed on selected servers of the enterprise's system, e.g., on an e-mail server, that prevents sensitive documents from being passed on to unauthorized destinations.

In network-based DLP, a DLP agent is placed at the gateway of the enterprise's system to the Internet so as to block all sensitive documents from leaving the enterprise's system.

DLP technology is defined as those that, as a core function, perform deep packet inspection on outbound network communications traffic, track sessions and perform linguistic analysis to detect, block or control the usage of specific content based on established rules or policies. The channels to be monitored may include e-mail traffic, Instant Messaging (IM), FTP, HTTP and other TCP/IP protocols.

In sum, conventional DLP uses agents to control real-time usage of documents, such as printing, e-mailing, and copying to CD. Particularly, conventional DLP places its agents where data is used, i.e., on the end-user PCs, servers or gateways.

The user of conventional DLPs is burdened with the need to develop, update and maintain patterns that identify sensitive documents. Alternatively, the DLP vendor has to do this work.

### SUMMARY

According to an embodiment of a first aspect of the invention, a method for locating documents for providing Data Leakage Prevention (DLP) within an Information Security Management System (ISMS) is suggested. The method has a step of, on each entity of the plurality of entities, calculating a respective fingerprint for each document of the documents stored on the entity, a step of transferring the calculated fingerprints by the entities to a data localization server having a fingerprint database for storing the transferred fingerprints, and a step of, at the data localization server, locating copies of a specimen document by calculating a fingerprint of the specimen document and comparing the calculated fingerprint of the specimen document with the fingerprints stored in the fingerprint database.

Embodiments of the invention may prevent data leakage in an Information System (IS) which has a plurality of entities capable of storing documents.

According to an embodiment of a second aspect of the invention, the invention relates to a computer program comprising a program code for executing the method for locating documents for providing Data Leakage Prevention (DLP) within an Information Security Management System (ISMS) when run on at least one computer.

According to some embodiments the work for developing, updating and maintaining patterns for identifying sensitive documents is eliminated as the user merely may have to point to the documents that may be sensitive. This may be beneficial, because it is difficult to write patterns that define what a sensitive document looks like. In the case of writing patterns, there are the risks of true positives and false negatives.

According to some implementations, data sprawl is controlled by controlling where the documents or data are stored. In this regard, according to embodiments of the present invention, agents for calculating the fingerprints may be stored where the documents are stored.

In an embodiment, the method has the step of determining documents of at least one defined document class, at the data localization server, locating all copies of a specimen document of said document class by calculating the fingerprint of the specimen document, and comparing the calculated fingerprint of the specimen document with the fingerprints stored in the fingerprint database.

In an embodiment, the method has the steps of determining documents of at least one defined document class, and, at the data localization server, locating all copies of specimen documents of said document class by calculating the fingerprints of the specimen documents and comparing the calculated fingerprints of the specimen documents with the fingerprints stored in the fingerprint database. The documents of one defined document class may be characterized by having similar or equal sensitivity, regulatory requirements or the like.

In a further embodiment, the method has the steps of determining documents of a defined document class indicating sensitive documents within the IS, and at the data localization server, locating all copies of a certain sensitive document by calculating a fingerprint of the specimen document and comparing the calculated fingerprint of the specimen document with the fingerprints stored in the fingerprint database.

In a further embodiment, a respective agent is installed on each entity of the plurality of entities, wherein the fingerprints of the documents stored on the respective entity are calculated by the respective agent. The respective agent may calculate the fingerprints of the documents stored on the corresponding entity in spare cycles of said corresponding entity.

In a further embodiment, the calculated fingerprints are transferred to the data localization server by the agents, wherein the transferred fingerprints are stored in the fingerprint database.

In a further embodiment, the location descriptors are provided in dependence on comparing the calculated fingerprint of the specimen document with the fingerprints stored in the fingerprint database, the provided location descriptors being configured to indicate the locations of the copies of the specimen document within the IS.

In a further embodiment, a definite location descriptor indicating a location of a definite document stored on one entity of the IS is provided if the fingerprint associated to that definite document stored in the fingerprint database is equal or similar to the calculated fingerprint of the specimen document.

In a further embodiment, a definite location descriptor indicating a location of a definite document stored on one entity of the IS is provided, if the fingerprint associated to that definite document stored in the fingerprint database is equal or similar to the calculated fingerprint of the specimen document, and if the definite document stored on one entity is equal or similar to the specimen document, wherein similarity of documents is determined by a separate algorithm.

In a further embodiment, the provided location descriptors are transferred to an ISMS control entity, the ISMS control entity being configured to query the fingerprint database of the data localization server.

According to an embodiment of a third aspect of the invention, the invention relates to a method for providing Data Leakage Prevention (DLP) of documents within an Information Security Management System (ISMS), the ISMS having a plurality of entities capable of storing the documents. The method has a step of locating the documents stored on the entities as described above with respect to the first aspect of the invention, a step of providing a respective security policy for each defined document class, and a step of applying the respective provided security policy to the located documents associated to the respective document class, for each defined document class.

The present security policies may define where and how data may be stored. This is in contrast to security policies in conventional DLPs, which define how data may be used.

In an embodiment, the respective security policy indicates a storage policy indicating which type or types of the entities have the right to store documents of the defined document class, and an action policy indicating at least one action to take when an entity tries to store a document of the defined document class without having the right to store documents of the defined document class according to the security policy.

In a further embodiment, the step of applying the respective provided security policy to the located documents associated to the respective document class includes transferring the respective provided security policy to all entities storing at least one document of the respective document class and enforcing the transferred security policy to the at least one document of the respective document class on the respective entity.

In a further embodiment, the method has the steps of storing a new document on an entity of the plurality of the entities, calculating a fingerprint of the stored new document, determining the document class of the stored new document in dependence on the calculated fingerprint, and applying the respective security policy associated to the determined document class to the stored new document.

According to an embodiment of a fourth aspect of the invention, the invention relates to a system for locating documents for providing Data Leakage Prevention (DLP) within an Information Security Management System (ISMS). The system has a plurality of entities for storing the documents, each entity of the plurality of entities having a respective agent, said respective agent being configured to calculate a respective fingerprint for each document of the documents stored on the entity and to transfer the calculated fingerprints to a data localization server having a fingerprint database for storing the transferred fingerprints, and the data localization server being configured to locate copies of a specimen document by calculating a fingerprint of the specimen document and comparing the calculated fingerprint of the specimen document with the fingerprints stored in the fingerprint database

According to an embodiment of a fifth aspect of the invention, the invention relates to an arrangement for providing Data Leakage Prevention (DLP) of documents within or as part of an Information Security Management System (ISMS). The arrangement has a system for locating documents according to the above mentioned embodiment of the fourth aspect of the invention, and an ISMS control entity for receiving a respective security policy for each defined document class and for applying the respective provided security policy to the located documents associated to the respective document class.

The agent may be any calculating means. Moreover, the ISMS control entity may be any controlling means.

The respective means, in particular the agent and the ISMS control entity, may be implemented in hardware or in software. If said means are implemented in hardware, it may be embodied as a device, e.g. as a computer or as a processor or as a part of a system, e.g. a computer system. If said means are implemented in software it may be embodied as a computer program product, as a function, as a routine, as a program code or as an executable object.

In the following, exemplary embodiments of the present invention are described with reference to the enclosed figures.

### BRIEF DESCRIPTION OF THE FIGURES

FIG. 1 shows a schematic block diagram illustrating data proliferation in a system;

FIG. 2 shows a first embodiment of a sequence of method steps for locating documents for providing Data Leakage Prevention within an Information Security Management System;

FIG. 3 shows a second embodiment of a sequence of method steps for locating documents for providing Data Leakage Prevention within an Information Security Management System;

FIG. 4 shows an embodiment of a sequence of method steps for providing Data Leakage Prevention of documents within an Information Security Management System, and

FIGS. 5A and B show a schematic block diagram of an embodiment of an arrangement for providing Data Leakage Prevention of documents within an Information Security Management System.

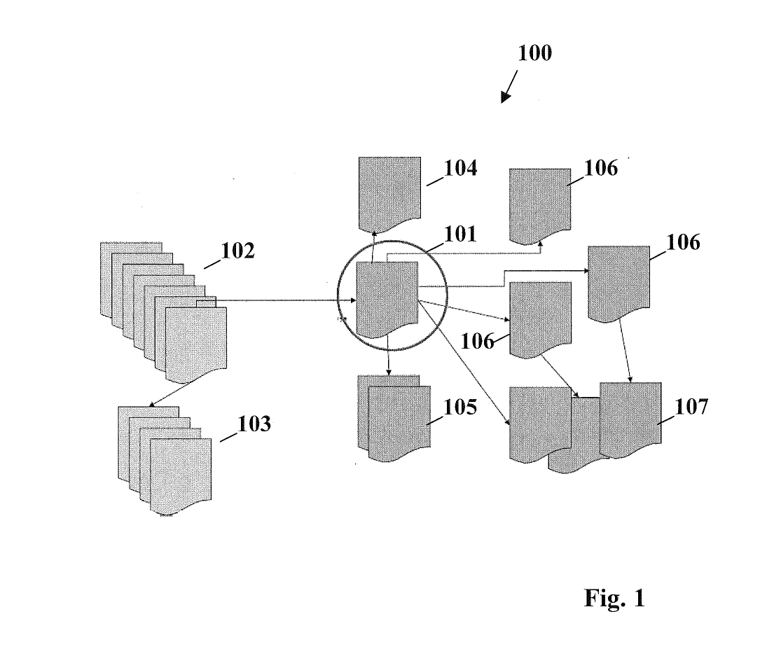

Similar or functionally similar elements in the figures have been allocated the same reference signs if not otherwise indicated.

### DETAILED DESCRIPTION

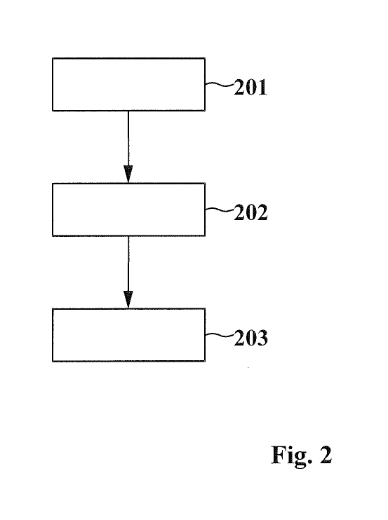

FIG. 2 shows a first embodiment of a sequence of method steps for locating documents for providing DLP within ISMS, the ISMS having a plurality of entities capable of storing documents.

In step 201, a respective fingerprint for each document of the documents stored on the respective entity is calculated. Step 201 may be performed on each entity of the plurality of entities of the ISMS.

In step 202, the calculated fingerprints are transferred by the entities to a data localization server having a fingerprint database for storing the transferred fingerprints.

In step 203, at the data localization server, all copies of a specimen document are located by calculating a fingerprint of the specimen document and comparing the calculated fingerprint of the specimen document with the fingerprints stored in the fingerprint database.

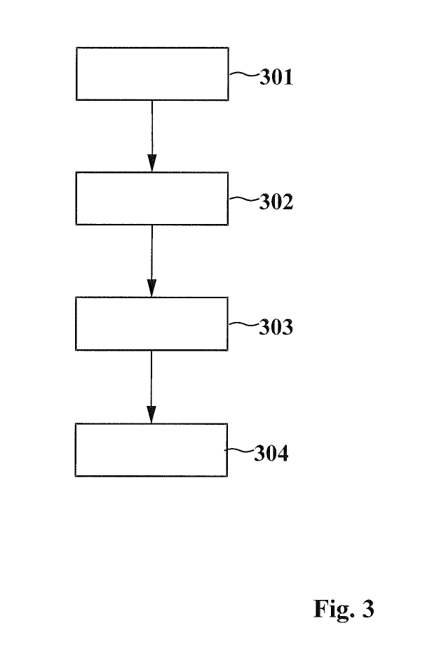

FIG. 3 depicts a second embodiment of sequence method steps for locating documents for providing DLP within ISMS.

In step 301, a respective fingerprint for each document of the documents stored on the respective entity is calculated. Said step 301 may be performed on each entity of the plurality of entities of the ISMS.

In step 302, the calculated fingerprints are transferred by the entities to a data localization server having a fingerprint database for storing the transferred fingerprints.

In step 303, documents of at least one defined document class are determined. In particular, said defined document class may indicate sensitive documents within the ISMS.

In step 304, at a data localization server, all copies of a specimen document of said document class are located by calculating the fingerprint of the specimen document and comparing the calculated fingerprint of the specimen document with the fingerprints stored in their fingerprint database.

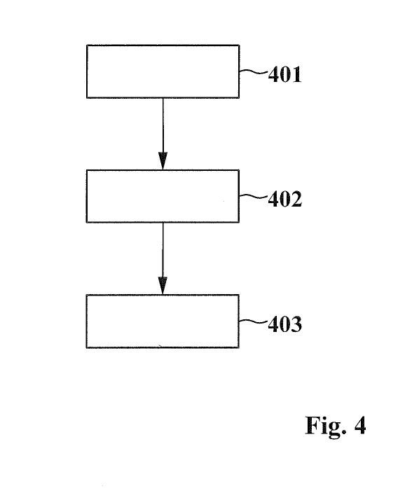

In FIG. 4, an embodiment of a sequence of method steps for providing DLP of documents within ISMS is shown.

In step 401, the documents stored on the entities are located. For applying step 401, the method of FIG. 2 or the method of FIG. 3 may be used.

In step 402, a respective security policy for each defined document class is provided.

Particularly, the respective security policy includes a storage policy indicating which type or types of the entities have the right to store documents of the defined document class, and an action policy indicating at least one action to take when an entity tries to store a document of the defined document class without having the right to store documents of the defined document class according to the security policy.

In step 403, for each defined document class, the respective provided security policy is applied to the located documents associated to the respective document class.

Particularly, the step 403 of applying the respective provided security policy to the located documents associated to the respective document class includes transferring the respective provided security policy to all entities storing at least one document of the respective document class and enforcing the transferred security policy on the at least one document of the respective document class on the respective entity.

Further, if a new document is stored on an entity of said plurality of entities, a fingerprint of the stored new document may be calculated and the document class of the stored new document may be determined in dependence on the calculated fingerprint. Subsequently, the respective security policy associated to the determined document class may be applied to said stored new document.

All above-mentioned embodiments of the methods of the present invention may be embodied by respective means to be a respective embodiment of the system or arrangement of the present invention.

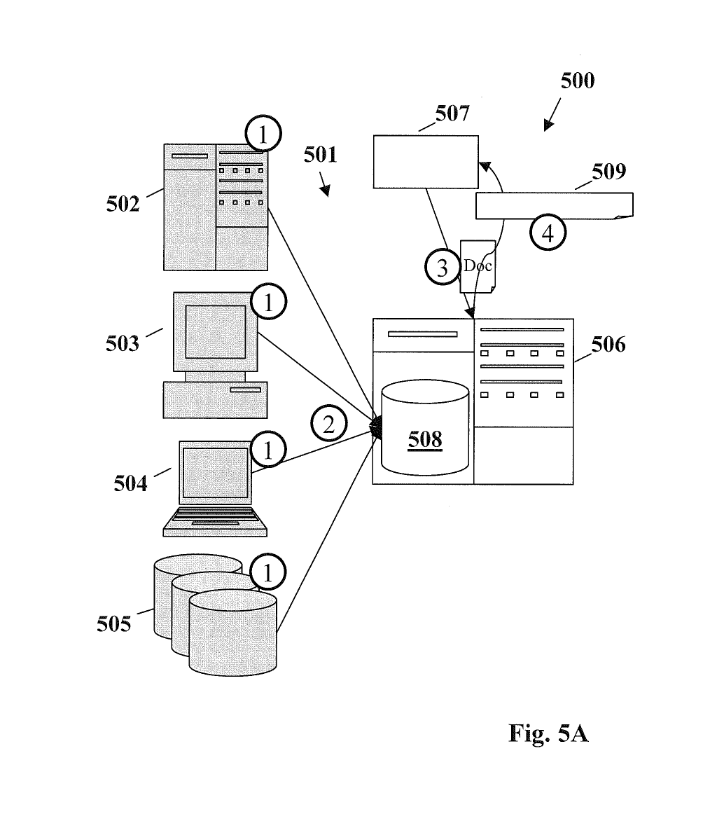

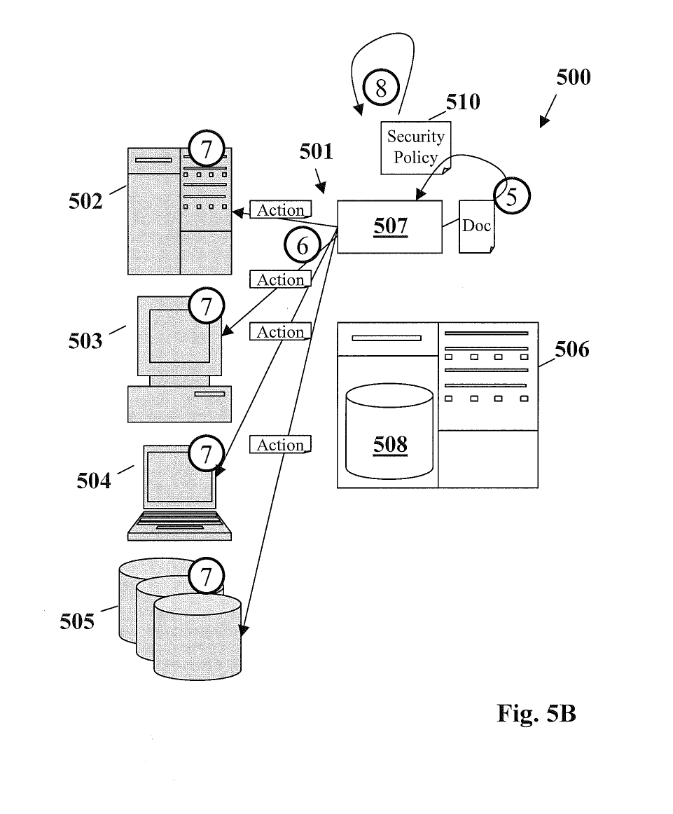

FIGS. 5A and 5B show a schematic block diagram of an embodiment of an arrangement 500 for providing DLP of documents within an ISMS 501. The ISMS 501 has a plurality of entities 502-505 which are capable of storing said documents. For example, there is a server 502, a PC 503, a laptop 504 and storage devices 505. Without loss of generality, the ISMS 501 FIGS. 5A and 5B has only four entities 502-505.

Further, said ISMS 501 has a data localization server 506 and an ISMS control entity 507 controlling or interrogating said data localization server 506.

An example of the functionality of said arrangement 500 is described in the following with reference to the steps 1-8 of FIGS. 5A and 5B. In particular, FIG. 5A shows the steps 1-4 for locating the documents in the ISMS 501, and FIG. 5B shows the steps 5-8 upon localizing all copies of a specimen document “Doc”.

In step 1, a respective agent is installed on each entity 502-505 of the ISMS 501. The respective agent calculates a respective fingerprint of the documents stored in the respective entity 502-505.

The purpose in step 1 is to crawl the memories, in particular the hard discs, of the entities 502-505 and to calculate said fingerprints for all documents found. A fingerprint may be a short, but characteristic summary of a document, e.g., the ten most frequent words other than utility words like “are”, “the” or the like.

In step 2, the calculated fingerprints are transferred from the entities 502-505 to the data localization server 506. The transferred fingerprints are stored in a fingerprint database 508 of said data localization server 506.

In particular, as documents change on the entities 502-505, the fingerprints may be updated on the data localization server 506. Alternatively, the agents may send entire documents to the fingerprint database 508, and fingerprints may be calculated centrally by the data localization server 506.

In step 3, the ISMS control entity 507 queries the fingerprint database 508 of the data localization server 506 by a specimen document Doc. By the inquiry, the ISMS control entity 507 asks data localization server 506 to locate all copies of the specimen document Doc. To answer this query, the data localization server 506 calculates the fingerprint of the specimen document Doc and searches the fingerprint database 508 with the calculated fingerprint for equal or similar fingerprints.

In this regard, two options may arise. First, the location of documents with similar or equal fingerprints may be returned directly. Second, it may be verified if in addition to having similar fingerprints, the full documents are either identical or highly similar, e.g. overlapping in large or parts.

In step 4, the locations descriptors 509 are provided in dependence on comparing the calculated fingerprint of the specimen document Doc with the fingerprint stored in the fingerprint database 508. The provided location descriptors 509 may be configured to indicate the locations of the copies of the specimen document Doc within the ISMS 501.

For example, a definite location descriptor indicating a location of the specimen document Doc stored on one entity 502-505 of the ISMS 501 is provided, if—(as indicated above) the fingerprint associated to said specimen document stored in the fingerprint database 508 is equal or similar to the calculated fingerprint of the specimen document Doc.

Referring now to FIG. 5B, in step 5, a respective security policy is retrieved for each defined document class.

For example, the respective security policy may include a storage policy and an action policy. The storage policy may indicate which type or types of the entities 502-505 have the right to store documents of the defined document class. The action policy may indicate at least one action to take when an entity tries to store a document of the defined document class without having the right to store documents of the defined document class according to the security policy.

For example, if the specimen document Doc has been classified, then a database (not shown) may return the security policy 510 applicable to its document class. Otherwise, a human operator may have to provide the applicable security policy.

Further, the storage policy may define the machine types that may store documents of the respective document class.

Furthermore, the action policy may define that actions to be taken in a definite case, for example delete a document, either automated, administrator-assisted, immediately or delayed. Further actions may be to replace by reference to a master copy, encrypt document, possibly temporarily or upgrade machine type to provide suitable controls.

The machine types may be defined by security officials and may distinguish machines based on the purpose, e.g., PC vs. server, on their administration, e.g. user-administered vs. professionally administered, on their localization, e.g. DMZ, Internet-facing or Intranet, on the controls they implement and their clearance, e.g. processing of public vs. sensitive vs. highly sensitive data or documents.

In step 6, for all entities or machines 502-505 that were found to store copies of the specimen document Doc, the actions that the security policy imposes are sent to the respective on-machine agents.

In step 7, the on-machine agents perform the actions imposed by the security policy.

Further, step 8 may show an alternative. After step 5, the ISMS 501 knows the security policy that applies to documents that have the same fingerprint like document Doc. Thus, this policy may henceforth be automatically be applied to all the documents that come in with the same fingerprint like said specimen document Doc.

What has been described herein is merely illustrative of the application of the principles of the present invention. Other arrangements and systems may be implemented by those skilled in the art without departing from the scope and spirit of this invention.

What is claimed is:

1. A method for locating documents for providing Data Leakage Prevention (DLP) within an Information Security Management System (ISMS), the ISMS having a plurality of entities capable of storing documents, the method comprising:
on each entity of the plurality of entities, calculating a respective fingerprint for each document of the documents stored on the entity;
transferring the calculated fingerprints by the entities to a data localization server having a fingerprint database for storing the transferred fingerprints; and
at the data localization server, locating copies of a specimen document by calculating a fingerprint of the specimen document and comparing the calculated fingerprint of the specimen document with the fingerprints stored in the fingerprint database.

2. The method of claim 1, further comprising:
determining documents of at least one defined document class, and
at the data localization server, locating all copies of a specimen document of said document class by calculating the fingerprint of the specimen document and comparing the calculated fingerprint of the specimen document with the fingerprints stored in the fingerprint database.

3. The method of claim 2, further comprising:
determining documents of a defined document class indicating sensitive documents within the ISMS; and
at the data localization server, locating all copies of a certain sensitive document by calculating a fingerprint of the specimen document and comparing the calculated fingerprint of the specimen document with the fingerprints stored in the fingerprint database.

4. The method of claim 3, wherein a respective agent is installed on each entity of the plurality of entities, wherein the fingerprints of the document stored on the respective entity are calculated by the respective agent.

5. The method of claim 4, wherein the calculated fingerprints are transferred to the data localization server by the agents, wherein the transferred fingerprints are stored in the fingerprint database.

6. The method of claim 5, wherein location descriptors are provided in dependence on comparing the calculated fingerprint of the specimen document with the fingerprints stored in the fingerprint database, the provided location descriptors being configured to indicate the locations of the copies of the specimen document within the ISMS.

7. The method of claim 6, wherein a definite location descriptor indicating a location of a definite document stored on one entity of the ISMS is provided if the fingerprint associated to that definite document stored in the fingerprint database is equal or similar to the calculated fingerprint of the specimen document.

8. The method of claim 7, wherein a definite location descriptor indicating a location of a definite document stored on one entity of the ISMS is provided, if the fingerprint associated to that definite document stored in the fingerprint database is equal or similar to the calculated fingerprint of the specimen document, and if the definite document stored on one entity is equal or similar to the specimen document, wherein a similarity of documents is determined by a separate algorithm.

9. The method of claim 8, wherein the provided location descriptors are transferred to an ISMS control entity, the ISMS control entity being configured to query the fingerprint database of the data localization server.

10. A method for providing Data Leakage Prevention (DLP) of documents within an Information Security Management System (ISMS), the ISMS having a plurality of entities capable of storing the documents, the method comprising:
locating the documents stored on the entities according to claim 2;
providing a respective security policy for each defined document class; and
for each defined document class, applying the respective provided security policy to the located documents associated to the respective document class.

11. The method of claim 10, wherein the respective security policy includes a storage policy indicating which type or types of the entities have the right to store documents of the defined document class, and an action policy indicating at least one action to take when an entity tries to store a document of the defined document class without having the right to store documents of the defined document class according to the security policy.

12. The method of claim 11, wherein the applying the respective provided security policy to the located documents associated to the respective document class includes transferring the respective provided security policy to all entities storing at least one document of the respective document class and enforcing the transferred security policy to the at least one document of the respective document class on the respective entity.

13. The method of claim 12, further comprising:
storing a new document on an entity of the plurality of the entities;
calculating a fingerprint of the stored new document;
determining the document class of the stored new document in dependence on the calculated fingerprint; and
applying the respective security policy associated to the determined document class to the stored new document.

14. A system for locating documents for providing Data Leakage Prevention (DLP) within an Information Security Management System (ISMS), the system comprising:
a plurality of entities for storing the documents, each entity of the plurality of entities having a respective agent, said respective agent being configured to calculate a respective fingerprint for each document of the documents stored on the entity and to transfer the calculated fingerprints to a data localization server having a fingerprint database for storing the transferred fingerprints; and
the data localization server being configured to locate copies of a specimen document (Doc) by calculating a fingerprint of the specimen document (Doc) and comparing the calculated fingerprint of the specimen document (Doc) with the fingerprints stored in the fingerprint database.

15. An arrangement for providing Data Leakage Prevention (DLP) of documents within an Information Security Management System (ISMS), the arrangement comprising:
a system for locating documents according to claim 14, and
an ISMS control entity for receiving a respective security policy for each defined document class and for applying the respective provided security policy to the located documents associated to the respective document class.

16. A non-transitory, computer readable storage medium having instructions stored thereon that, when executed by a computer implement a method for locating documents for providing Data Leakage Prevention (DLP) within an Information Security Management System (ISMS), the ISMS having a plurality of entities capable of storing documents, the method comprising:
on each entity of the plurality of entities, calculating a respective fingerprint for each document of the documents stored on the entity;
transferring the calculated fingerprints by the entities to a data localization server having a fingerprint database for storing the transferred fingerprints; and
at the data localization server, locating copies of a specimen document by calculating a fingerprint of the specimen document and comparing the calculated fingerprint of the specimen document with the fingerprints stored in the fingerprint database.
